(19) United States
(12) Patent Application Publication
(10) Pub. No.: US 2021/0081159 A1
(43) Pub. Date: Mar. 18, 2021

(54) ELECTRONIC DEVICE AND METHOD FOR MANAGING POWER SOURCE OF ELECTRONIC DEVICE

(71) Applicant: NEC Display Solutions, Ltd., Tokyo (JP)

(72) Inventor: Yasunobu KANEKO, Tokyo (JP)

(21) Appl. No.: 16/955,578

(22) PCT Filed: Jan. 19, 2018
(86) PCT No.: PCT/JP2018/001601

§ 371 Date: Jun. 18, 2020

(51) Int. Cl. G06F 3/14; G09G 3/36; G06F 1/26

(52) U.S. Cl. CPC G06F 3/1446; G09G 3/36; G06F 1/26; G09G 2300/026; G09G 2330/026; G09G 2310/08; G09G 2330/025

(57) ABSTRACT

An electronic device includes: a receiver that receives inrush current information representing an inrush current when another electronic device is started up and that is transmitted from the other electronic device; an inrush current acquirer that acquires an inrush current when the electronic device is started up; an inrush current totalizer that totals the inrush current when the other electronic device is started up and the inrush current when the electronic device is started up; a timing determiner that determines timings when the electronic device and the other electronic device are respectively started up on the basis of a total value of the inrush current of the electronic device and the inrush current of the other electronic device and a current reference value representing a simultaneously applicable current value; and a transmitter that transmits power-on timing information representing the determined timings to the other electronic device.

### TECHNICAL FIELD

The present invention relates to an electronic device and a method for managing a power source of an electronic device.

### BACKGROUND ART

In recent years, image display apparatuses, such as projectors and liquid crystal monitors, are arranged in a matrix to increase the resolutions of images to be displayed (e.g., Patent Document 1). Under the above-described multi-display environment, a structure in which power is supplied from the same circuit breaker or the same outlet to image display apparatuses is normally used. In this structure, if the power sources of a plurality of image display apparatuses are turned on all at once, an excess current is generated, and thus there is a risk that a circuit breaker trips and/or the image display apparatuses are broken. For this reason, conventionally, a power-on delay function is provided, different delay times are set for image display apparatuses that configure a multi-display, and control that shifts the timings when the power sources of the image display apparatuses are turned on is performed with respect to control the turning-on of the power sources of the plurality of image display apparatuses (e.g., Patent Document 2).

### PRIOR ART DOCUMENTS

### Patent Documents

Patent Document 1: Japanese Unexamined Patent Application, First Publication No. 2003-46751

Patent Document 2: Pamphlet of PCT International Publication No. WO 2014/132422

### SUMMARY OF THE INVENTION

### Problems to be Solved by the Invention

However, in order to set a power-on delay function, it is necessary for a user to manually set different delay times for image display apparatuses of which power sources are to be turned on all at once for each of the image display apparatuses using an on-screen display (OSD) menu screen, and thus much labor is required for the setting. Moreover, it is necessary to prepare time widths that correspond to setting values of delay times to be set for image display apparatuses, wherein the number of the time widths is equal to the number of the image display apparatuses for which the delay times are to be set, that is, (the number of the image display apparatuses−1)×a unit delay time. Here, the unit delay time is a unit of time width that is used when delays are sequentially applied to the image display apparatuses. For example, when the power sources of 100 display image apparatuses are sequentially turned on with a unit delay time width of 3 seconds, a delay time for the first display image apparatus is set to 0 seconds, a delay time for the second display image apparatus is set to 3 seconds, a delay time for the third display image apparatus is set to 6 seconds, and a delay time for the 100^{th} display image apparatus is set to 297 seconds. It is necessary for a user to manually set all of these delay times precisely, and thus the labor of the user is increased.

In order to solve these problems, a technique of allocating ID numbers to a plurality of screen display apparatuses that are connected, multiplying the ID numbers by a unit delay time, which is stored in advance in a recording apparatus, and shifting the timings when the power sources of the image display apparatuses are turned on using the multiplication results as the delay times for the image display apparatuses themselves is proposed. However, in this case, when a great number of image display apparatuses are connected, a longer delay time is set for a screen display apparatus that is connected at a subsequent stage, and thus a user must wait for a long time from when operations of turning on the power sources are performed until when screen displays of all the image display apparatuses can be confirmed. For example, when the power sources of 100 display image apparatuses are sequentially turned on with a unit delay time width of 3 seconds, a delay time for the 100^{th} display image apparatus is set to (3 seconds×99=297 seconds).

In view of the above-described problems, an example object of the present invention is to provide an electronic device and a method for managing a power source of an electronic device that are capable of reducing the labor of a user and shortening the time from when operations of turning on the power sources are performed until when all the electronic devices become operable.

### Means for Solving the Problems

In order to solve the above-described problem, an electronic device in accordance with an example aspect of the present invention includes: a reception unit that receives inrush current information that represents an inrush current when another electronic device is started up and that is transmitted from the other electronic device; an inrush current acquisition unit that acquires an inrush current when the electronic device itself is started up; an inrush current totaling unit that totals the inrush current when the other electronic device is started up and the inrush current when the electronic device itself is started up; a timing determination unit that determines timings when the electronic device itself and the other electronic device are respectively started up on the basis of a total value of the inrush current of the electronic device itself and the inrush current of the other electronic device and a current reference value representing a simultaneously applicable current value; and a transmission unit that transmits power-on timing information representing the determined timings to the other electronic device.

A method for managing a power source of an electronic device in accordance with an example aspect of the present invention includes: receiving inrush current information that represents an inrush current when another electronic device is started up and that is transmitted from the other electronic device; acquiring an inrush current when the electronic device itself is started up; totaling the inrush current when the other electronic device is started up and the inrush current when the electronic device itself is started up; determining timings when the electronic device itself and the other electronic device are respectively started up on the basis of a total value of the inrush current of the electronic device itself and the inrush current of the other electronic device and a current reference value representing a simultaneously applicable current value; and transmitting power-on timing information representing the determined timings to the other electronic device.

### Example Advantages of the Invention

With the present invention, when a system is constructed with a plurality of electronic devices, it is possible to shorten the time from when operations of turning on the power sources are performed until when all the electronic devices become operable.

### BRIEF DESCRIPTION OF THE DRAWINGS

FIG. 1 is a diagram describing an outline of a multi-display system in accordance with a first example embodiment of the present invention.

FIG. 2 is a block diagram showing the structure of an example of an image display apparatus in accordance with the first example embodiment of the present invention.

FIG. 3 is a diagram describing a connection state when the multi-display system is constructed with a plurality of image display apparatuses.

FIG. 4 is a diagram describing power supply to the image display apparatuses, which configure the multi-display system.

FIG. 5 is a diagram describing an example of an inrush current table that shows a correspondence relationship between setting values for a backlight and inrush currents.

FIG. 6 is a diagram describing an example of a power-on delay setting screen.

FIG. 7 is a functional block diagram based on the operation of a master-side image display apparatus in accordance with the first example embodiment of the present invention.

FIG. 8 is a functional block diagram based on the operation of a slave-side image display apparatus in accordance with the first example embodiment of the present invention.

FIG. 9 is a sequence diagram showing the processing until a power-on delay function is set in the multi-display system in accordance with the first example embodiment of the present invention.

FIG. 10 is a sequence diagram showing the processing until the power-on delay function is set in the multi-display system in accordance with the first example embodiment of the present invention.

FIG. 11 is a sequence diagram showing a power source management process using a power-on delay function in the multi-display system 1 in accordance with the first example embodiment of the present invention.

FIG. 12 is a schematic block diagram showing a basic structure of an image display apparatus in accordance with the present invention.

### MODES FOR CARRYING OUT THE INVENTION

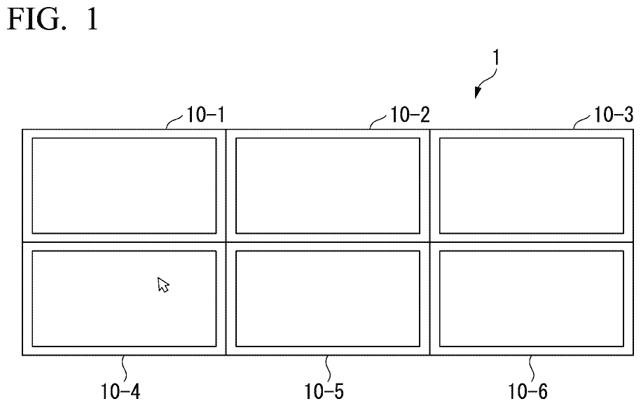

Hereinbelow, example embodiments of the present invention will be described with reference to the drawings. FIG. 1 is a diagram describing an outline of a multi-display system in accordance with a first example embodiment of the present invention. This example embodiment describes a case which an image display apparatus is applied as an example of an electronic device.

As shown in FIG. 1, a multi-display system 1 in accordance with the first example embodiment of the present invention is configured by arranging a plurality of image display apparatuses 10-1 to 10-6 in a matrix. In this example, a total of the six image display apparatuses 10-1 to 10-6 are arranged, wherein three image display apparatuses are arranged in the horizontal direction and two image display apparatuses are arranged in the vertical direction. The image display apparatuses 10-1 to 10-6 are, for example, projectors or liquid crystal monitors.

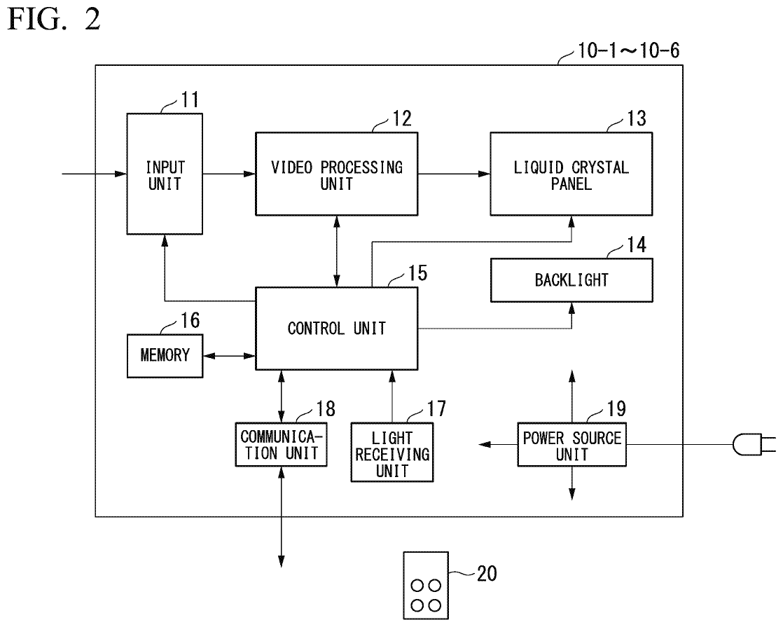

FIG. 2 is a block diagram showing the structure of an example of each of the image display apparatuses 10-1 to 10-6 in accordance with the first example embodiment of the present invention. It is to be noted that liquid crystal monitors are used as the image display apparatuses 10-1 to 10-6 in this example, but a basic structure thereof when projectors are used is similar to that when the liquid crystal monitors are used.

As shown in FIG. 2, each of the image display apparatuses 10-1 to 10-6 is configured to include an input unit 11, a video processing unit 12, a liquid crystal panel 13, a backlight 14, a control unit 15, a memory 16, a light receiving unit 17, a communication unit 18, and a power source unit 19.

The input unit 11 is provided with a video input terminal, such as a high definition multimedia interface (HDMI (registered trademark)) input terminal, a video graphics array (VGA) input terminal, an RGB input terminal, or a composite video input terminal. The input unit 11 selects an input video signal under control of the control unit 15 and outputs the selected video signal to the video processing unit 12.

The video processing unit 12 performs various video processes, such as luminance correction, color correction, adjustment of the position of a screen and the size of the screen, on the video signal from the input unit 11 on the basis of control of the control unit 15. An output of the video processing unit 12 is supplied to the liquid crystal panel 13.

The liquid crystal panel 13 displays an image based on the video signal from the video processing unit 12. The backlight 14 is disposed on the back surface of the liquid crystal panel 13. The backlight 14 irradiates transmission light to the liquid crystal panel 13 on the basis of control of the control unit 15.

The control unit 15 is configured with, for example, a central processing unit (CPU) and performs overall control of the device on the basis of a program. The memory 16 is provided for the control unit 15. The memory 16 reads and writes various kinds of data to be processed on the basis of the program.

The light receiving unit 17 is provided for the control unit 15. The light receiving unit 17 optically receives infrared-ray command signals from a remote controller 20 and supplies the command signals to the control unit 15. The control unit 15 performs settings for various operations on the basis of the command signals.

Moreover, the communication unit 18 is provided for the control unit 15. As the communication unit 18, RS232C (universal asynchronous receiver/transmitter (UART)), a wired local area network (LAN), or the like is used.

The power source unit 19 converts the commercial power source into a power source of a desired voltage and supplies the converted power source to the respective units inside the device.

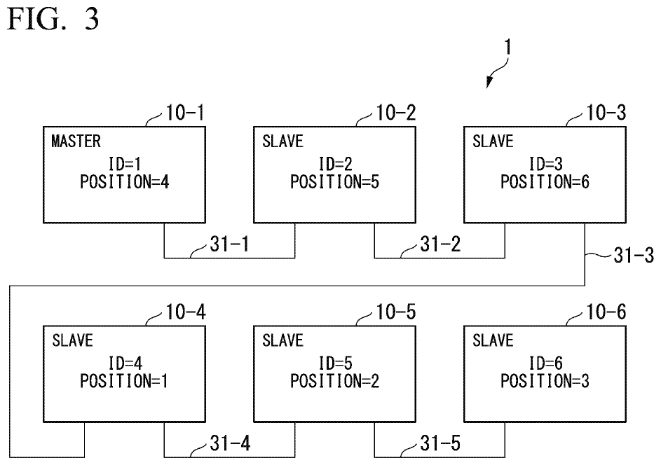

FIG. 3 is a diagram describing a connection state when the multi-display system 1 is constructed with the plurality of image display apparatuses 10-1 to 10-6. As shown in FIG. 3, the image display apparatus 10-1 is connected to the image display apparatus 10-2 via a signal line 31-1. The image display apparatus 10-2 is connected to the image display apparatus 10-3 via a signal line 31-2. The image display apparatus 10-3 is connected to the image display apparatus 10-4 via a signal line 31-3. The image display apparatus 10-4 is connected to the image display apparatus 10-5 via a signal line 31-4. The image display apparatus 10-5 is connected to the image display apparatus 10-6 via a signal line 31-5. The signal lines 31-1 to 31-5 connect the communication units 18 (FIG. 2) provided in the image display apparatuses 10-1 to 10-6, and LAN cables, RS232C cables, or the like are used as the signal lines 31-1 to 31-5. The image display apparatuses 10-1 to 10-6 are daisy-chain connected using these signal lines 31-1 to 31-5, and data can be transmitted and received among the image display apparatuses 10-1 to 10-6.

The multi-display system 1 has an automatic ID allocation function. This is a function of automatically allocating ID numbers that are unique to the display apparatuses to the image display apparatuses 10-1 to 10-6. When the automatic ID allocation function is executed, ID numbers of ID1 to ID6 are allocated to the image display apparatuses 10-1 to 10-6, respectively. Of the image display apparatuses 10-1 to 10-6, for example, the image display apparatus 10-1, to which the ID number of ID1 is allocated, becomes a master and the other image display apparatuses 10-2 to 10-6 become slaves. The master-side image display apparatus 10-1 uses the ID numbers to determine, for example, the number of the connected image display apparatuses 10-1 to 10-6, which configure the multi-display system 1, and an image display apparatus from which a command response has been received among the image display apparatuses 10-1 to 10-6. Moreover, in the multi-display system 1 in accordance with the present example embodiment, position numbers can be set, in addition to the IDs.

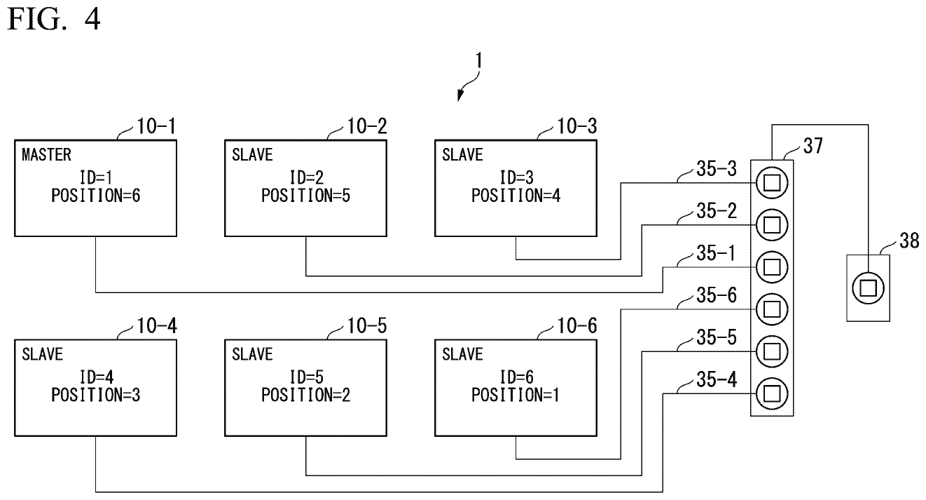

FIG. 4 is a diagram describing power supply to the image display apparatuses 10-1 to 10-6, which configure the multi-display system 1. Because the image display apparatuses 10-1 to 10-6, which configure the multi-display system 1, are provided at close positions, it is likely that power is supplied from the same outlet or circuit breakers belonging to the same system. In this example, power is supplied from the same outlet 38 to the image display apparatuses 10-1 to 10-6, as shown in FIG. 4.

That is, power cords 35-1 to 35-6 are provided for the image display apparatuses 10-1 to 10-6. The power cords 35-1 to 35-6 supply power to the power source units 19 (FIG. 2) provided in the image display apparatuses 10-1 to 10-6. The plugs at the tips of the power cords 35-1 to 35-6 are inserted in the same power strip 37. The plug of the power strip 37 is inserted in the outlet 38.

Here, when operations of turning on the power sources are simultaneously performed on the image display apparatuses 10-1 to 10-6, a current flows from the same outlet 38 to the image display apparatuses 10-1 to 10-6 through the same power strip 37. A high inrush current flows through the image display apparatuses 10-1 to 10-6 when the power sources are turned on.

In order to address the high inrush current, the image display apparatuses 10-1 to 10-6 in accordance with the present example embodiment are provided with a power-on delay function. The power-on delay function is a function of separating the timings when the power sources of the image display apparatuses 10-1 to 10-6 are turned on so that the power sources of the plurality of image display apparatuses 10-1 to 10-6 are not turned on simultaneously. In the present example embodiment, when the timings of turning on the power sources are set by the power-on delay function, division of the image display apparatuses 10-1 to 10-6 into groups and a setting of a power-on delay time for each of the groups are performed on the basis of the total value of the inrush currents of the image display apparatuses 10-1 to 10-6 and a simultaneously applicable current so that the total of the inrush currents is less than or equal to the simultaneously applicable current. This process will be described below.

In this example, the multi-display system 1 is configured with the six image display apparatuses 10-1 to 10-6 as described above. Here, it is assumed that the inrush current of each of the image display apparatuses 10-1 to 10-6 is, for example, 20 A. Moreover, it is assumed that the simultaneously applicable current is 100 A.

Assuming that the inrush current per image display apparatus is, for example, 20 A, when the power sources of the six image display apparatuses 10-1 to 10-6 are turned on all at once, the total current becomes (20 A×6=120 A). This means that the total current exceeds the simultaneously applicable current of 100 A. When the number of image display apparatuses of which power sources are turned on all at once is reduced to five, the total current becomes (20 A×5=100 A) and thus the total of the inrush currents is less than or equal to the simultaneously applicable current (100 A). Accordingly, in this case, the image display apparatuses 10-1 to 10-6 are divided into groups so that the combinations of the image display apparatuses satisfy a condition that the number of the image display apparatuses included in each group is less than or equal to five.

Specifically, the master-side image display apparatus 10-1 sends an inrush current acquisition request to the slave-side image display apparatuses 10-2 to 10-6. An inrush current can be calculated by referring to an inrush current table that is stored in the memory 16 and that shows a correspondence relationship between setting values for the backlight and inrush currents. The values in the inrush current table are dependent on the model.

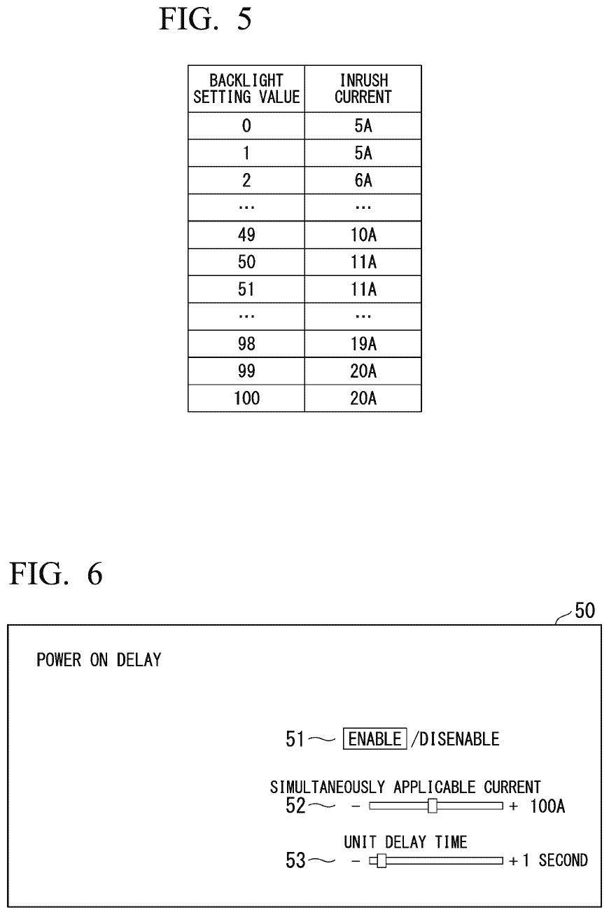

FIG. 5 is a diagram describing an example of the inrush current table, which shows a correspondence relationship between setting values for the backlight and inrush currents. It can be seen from this inrush current table that when a setting value for the backlight is, for example, “100”, an inrush current is 20 A. When the slave-side image display apparatuses 10-2 to 10-6 receive the inrush current acquisition request, the slave-side image display apparatuses 10-2 to 10-6 refer to the inrush current tables to acquire inrush current information and transmits this inrush current information to the master-side image display apparatus 10-1.

The master-side image display apparatus 10-1 totals the inrush currents transmitted from the slave-side image display apparatuses 10-2 to 10-6 and the inrush current of the master-side image display apparatus 10-1 itself and performs grouping so that the total of the inrush currents is less than or equal to the simultaneously applicable current. Then, the master-side image display apparatus 10-1 sets power-on delay times for the groups and transmits setting values of the power-on delay times to the slave-side image display apparatuses 10-2 to 10-6.

A setting value of the simultaneously applicable current is recorded in the master-side image display apparatus 10-1 in advance as a recommended value, and a user can change the simultaneously applicable current after a shipment from a factory. The user can change the value of the simultaneously applicable current taking allowable current values of the power strip 37 and the outlet 38, the capacity of the circuit breakers, and so forth into consideration. It is assumed that a setting value of the unit delay time is recorded in the master-side image display apparatus 10-1 in advance as a recommended value and the user can change the unit delay time after a shipment from a factory. The recommended value of the unit delay time is a time from when the power source of each of the image display apparatuses 10-1 to 10-6 is turned on until when the current in each of the image display apparatuses 10-1 to 10-6 becomes sufficiently stable.

FIG. 6 is a diagram describing an example of a power-on delay setting screen 50. This setting screen 50 is displayed using an on-screen display (OSD) menu screen of the master-side image display apparatus 10-1. As shown in FIG. 6, the setting screen 50 of the power-on delay function includes a setting screen 51 for enabling and disenabling the power-on delay function, a setting screen 52 for the simultaneously applicable current, and a setting screen 53 for the unit delay time. The user can change the simultaneously applicable current and the unit delay time by operating these screens.

As described before, assuming that the inrush current of each of the image display apparatuses 10-1 to 10-6 is, for example, 20 A and the simultaneously applicable current is 100 A, it is possible to perform grouping that satisfies a condition that the total of the inrush currents is less than or equal to the simultaneously applicable current by combining and grouping the image display apparatuses so that the number of image display apparatuses included in each group is less than or equal to five. The grouping is performed on the basis of, for example, ID numbers. That is, in this example, ID numbers of ID1 to ID6 are allocated to the image display apparatuses 10-1 to 10-6, respectively. In this case, the image display apparatuses 10-1 to 10-5 having ID1 to ID5 (which correspond to the ID numbers of five image display apparatuses) are grouped as a group #1 and the image display apparatus 10-6 having ID6 (which corresponds to the remaining ID number) is grouped as a group #2. Then, a power-on delay time for the image display apparatuses 10-1 to 10-5 belonging to the group #1 is set to zero seconds, and a power-on delay time for the image display apparatus 10-6 belonging to the group #2 is set in units of predetermined unit delay time widths (e.g., one second).

By setting the power-on delay times for the image display apparatuses 10-1 to 10-6 in this manner, when operations of turning on the power sources are simultaneously performed on the image display apparatuses 10-1 to 10-6 next time, the power sources of the image display apparatuses 10-1 to 10-5 belonging to the group #1 are immediately turned on once the operations of turning on the power sources are performed, and the power source of the image display apparatus 10-6 belonging to the group #2 is turned on after a power-on delay time of one second has passed from when the operations of turning on the power sources are performed.

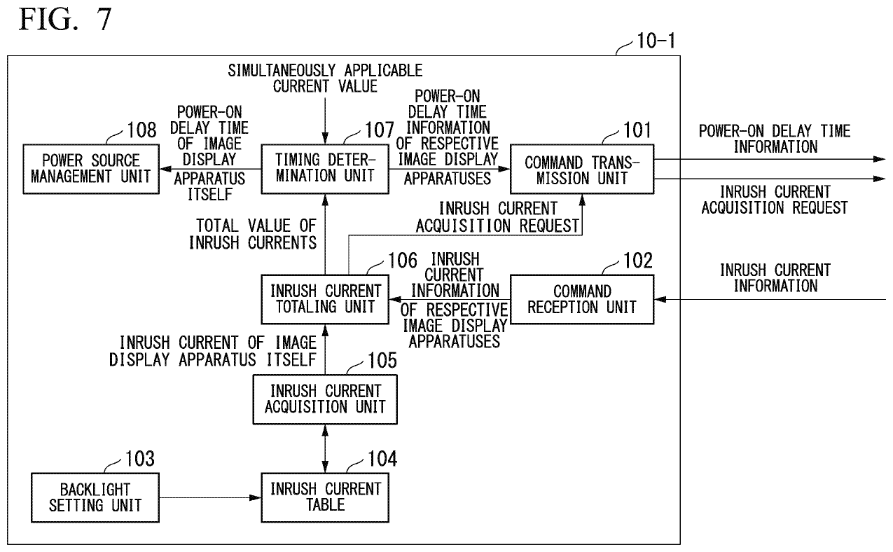

FIG. 7 is a functional block diagram showing the operation of the master-side image display apparatus 10-1 in accordance with the first example embodiment of the present invention. As shown in FIG. 7, the master-side image display apparatus 10-1 is configured to include a command transmission unit 101, a command reception unit 102, a backlight setting unit 103, an inrush current table 104, an inrush current acquisition unit 105, an inrush current totaling unit 106, a timing determination unit 107, and a power source management unit 108.

The command transmission unit 101 transmits an inrush current acquisition request to the slave-side image display apparatuses 10-2 to 10-6. Moreover, the command transmission unit 101 transmits power-on delay time information to the slave-side image display apparatuses 10-2 to 10-6.

The command reception unit 102 receives inrush current information transmitted from the slave-side image display apparatuses 10-2 to 10-6.

The backlight setting unit 103 sets the quantity of light of the backlight 14 of the master-side image display apparatus itself in accordance with an operation by the user.

The inrush current table 104 is a table showing a correspondence relationship between setting values for the backlight and inrush currents, and the inrush current table 104 is configured as shown in FIG. 5.

The inrush current acquisition unit 105 refers to the inrush current table 104 and acquires an inrush current of the master-side image display apparatus itself on the basis of the setting value for the backlight of the master-side image display apparatus itself.

The inrush current totaling unit 106 transmits the inrush current acquisition request to the slave-side image display apparatuses 10-2 to 10-6, and when the inrush current totaling unit 106 receives the inrush current information from the slave-side image display apparatuses 10-2 to 10-6, the inrush current totaling unit 106 totals the inrush current information transmitted from the slave-side image display apparatuses 10-2 to 10-6 and the inrush current of the master-side image display apparatus itself.

The timing determination unit 107 divides the image display apparatuses into groups on the basis of the total value of the inrush currents of the slave-side image display apparatuses 10-2 to 10-6 and the inrush current of the master-side image display apparatus itself and the value of the simultaneously applicable current by combining the image display apparatuses so that the total of the inrush currents is less than or equal to the value of the simultaneously applicable current, and determines power-on delay times for the image display apparatuses 10-1 to 10-6 for each of the groups. The power-on delay time for the master-side image display apparatus itself is sent to the power source management unit 108. Moreover, the power-on delay time information for the slave-side image display apparatuses 10-2 to 10-6 is transmitted from the command transmission unit 101 toward the slave-side image display apparatuses 10-2 to 10-6.

The power source management unit 108 sets a power-on delay time on the basis of the power-on delay time for the master-side image display apparatus itself determined by the timing determination unit 107.

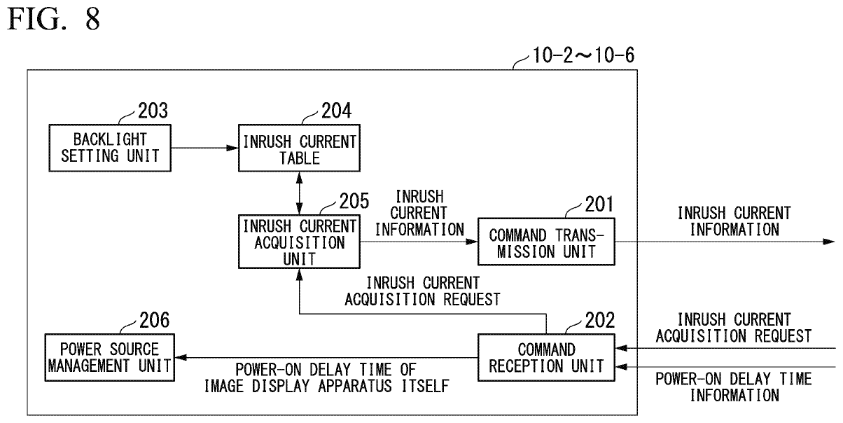

FIG. 8 is a functional block diagram showing the operation of each of the slave-side image display apparatuses 10-2 to 10-6 in accordance with the first example embodiment of the present invention. As shown in FIG. 8, each of the slave-side image display apparatuses 10-2 to 10-6 is configured to include a command transmission unit 201, a command reception unit 202, a backlight setting unit 203, an inrush current table 204, an inrush current acquisition unit 205, and a power source management unit 206.

The command transmission unit 201 transmits inrush current information to the master-side image display apparatus 10-1.

The command reception unit 202 receives an inrush current acquisition request from the master-side image display apparatus 10-1.

The backlight setting unit 203 sets the quantity of light of the backlight 14 of each of the slave-side image display apparatuses themselves in accordance with an operation by the user.

The inrush current table 204 is a table showing a correspondence relationship between setting values for the backlight and inrush currents, and the inrush current table 204 is configured as shown in FIG. 5.

When the inrush current acquisition unit 205 receives the inrush current acquisition request from the master-side image display apparatus 10-1, the inrush current acquisition unit 205 refers to the inrush current table 204 and acquires an inrush current of each of the slave-side image display apparatuses themselves on the basis of the setting value for the backlight of each of the slave-side image display apparatuses themselves. The acquired inrush current information is sent from the command transmission unit 201 toward the master-side image display apparatus 10-1.

As described before, the master-side image display apparatus 10-1 combines and groups the image display apparatuses so that the total of the inrush currents is less than or equal to the value of the simultaneously applicable current, determines the power-on delay times for the image display apparatuses 10-1 to 10-6 for each of the groups, and transmits power-on delay time information to the slave-side image display apparatuses 10-2 to 10-6. When the power source management unit 206 receives the power-on delay time information from the master-side image display apparatus 10-1, the power source management unit 206 sets the power-on delay time for each of the slave-side image display apparatuses themselves.

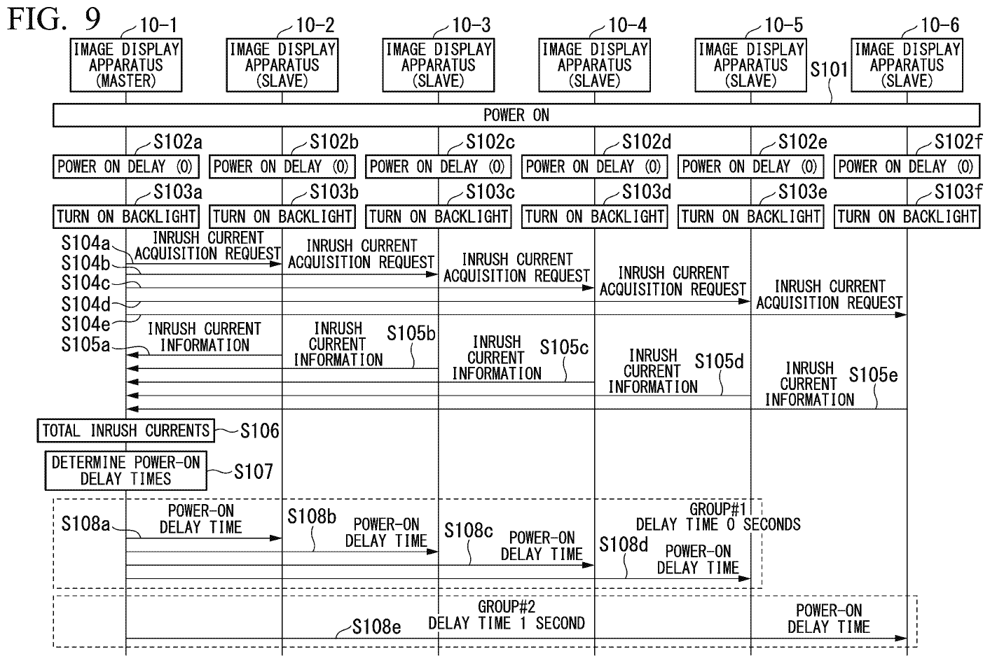

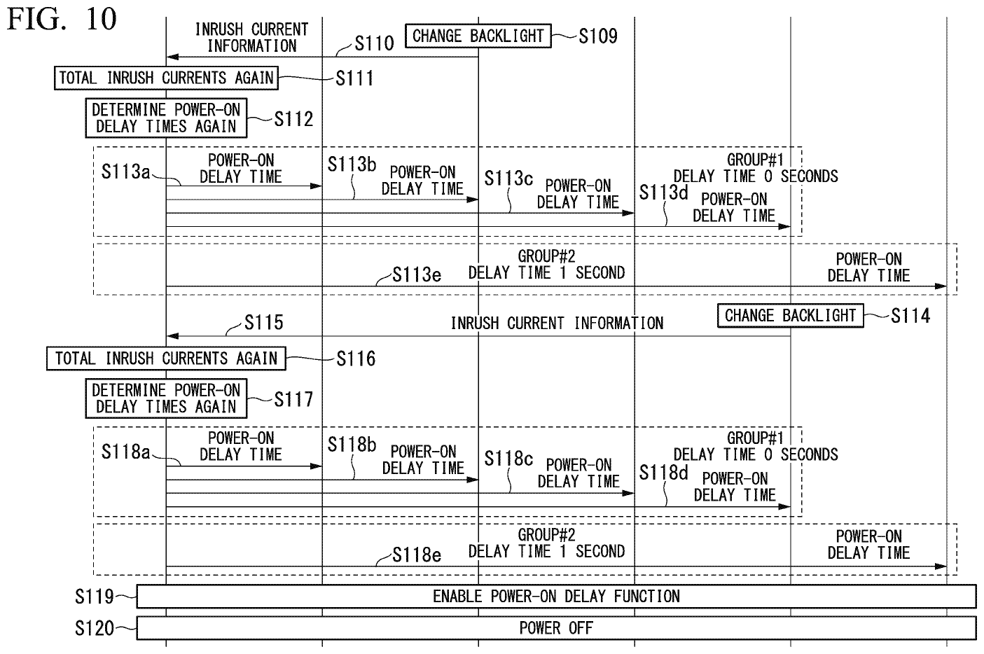

FIG. 9 and FIG. 10 are sequence diagrams showing the processing until a power-on delay function is set in the multi-display system 1 in accordance with the first example embodiment of the present invention.

### (Step S101)

A user performs operations of turning on the power sources to give power-on instructions to the image display apparatuses 10-1 to 10-6.

### (Steps S102a to 102f)

In the initial state at the time of a shipment from a factory, power-on delay times are not set for the image display apparatuses 10-1 to 10-6. For this reason, the power sources of the image display apparatuses 10-1 to 10-6 are immediately turned on.

### (Steps S103a to 103f)

When the power sources of the image display apparatuses 10-1 to 10-6 are turned on, each of the image display apparatuses 10-1 to 10-6 turns on the backlight 14.

### (Steps S104a to 104e)

The master-side image display apparatus 10-1 transmits an inrush current acquisition request to the slave-side image display apparatuses 10-2 to 10-6. Each of the image display apparatuses 10-1 to 10-6 refers to the inrush current table and acquires an inrush current on the basis of the setting value for the backlight.

### (Steps S105a to 105e)

The slave-side image display apparatuses 10-2 to 10-6 transmit inrush current information thereof to the master-side image display apparatus 10-1.

### (Step S106)

The master-side image display apparatus 10-1 totals the inrush currents sent from the slave-side image display apparatuses 10-2 to 10-6 and the inrush current of the master-side image display apparatus 10-1 itself.

### (Step S107)

The master-side image display apparatus 10-1 performs grouping so that the total of the inrush currents is less than or equal to the simultaneously applicable current, sets a delay time for each of the groups, and determines power-on delay times for the image display apparatuses 10-1 to 10-6. In this example, the image display apparatuses 10-1 to 10-5 having ID1 to ID5 are grouped as a group #1 and the image display apparatus 10-6 having ID6 is grouped as a group #2. Then, a power-on delay time for the image display apparatuses 10-1 to 10-5 belonging to the group #1 is set to “zero seconds” and a power-on delay time for the image display apparatus 10-6 belonging to the group #2 is set to “one second”.

### (Steps S108a to 108e)

The master-side image display apparatus 10-1 transmits the power-on delay times to the slave-side image display apparatuses 10-2 to 10-6.

### (Step S109)

Here, it is assumed that the image display apparatus 10-3 has changed the setting value for the backlight. When the setting value for the backlight is changed, the inrush current is changed. The image display apparatus 10-3 refers to the inrush current table and acquires an inrush current on the basis of the changed setting value for the backlight.

### (Step S110)

The image display apparatus 10-3 transmits inrush current information to the master-side image display apparatus 10-1.

### (Step S111)

The master-side image display apparatus 10-1 totals the inrush currents of the slave-side image display apparatuses 10-2 to 10-6 and the inrush current of the master-side image display apparatus 10-1 itself again in accordance with the changed value of the inrush current of the image display apparatus 10-3.

### (Step S112)

The master-side image display apparatus 10-1 performs grouping so that the total of the inrush currents is less than or equal to the simultaneously applicable current, sets a power-on delay time for each of the groups, and determines power-on delay times for the image display apparatuses 10-1 to 10-6.

### (Steps S113a to 113e)

The master-side image display apparatus 10-1 transmits the power-on delay times to the slave-side image display apparatuses 10-2 to 10-6.

### (Step S114)

Here, it is assumed that the image display apparatus 10-5 has changed the setting value for the backlight. When the setting value for the backlight is changed, the inrush current is changed. The image display apparatus 10-3 refers to the inrush current table and acquires an inrush current on the basis of the changed setting value for the backlight.

### (Step S115)

The image display apparatus 10-5 transmits inrush current information to the master-side image display apparatus 10-1.

### (Step S116)

The master-side image display apparatus 10-1 totals the inrush currents of the slave-side image display apparatuses 10-2 to 10-6 and the inrush current of the master-side image display apparatus 10-1 itself again in accordance with the changed value of the inrush current of the image display apparatus 10-6.

### (Step S117)

The master-side image display apparatus 10-1 performs grouping so that the total of the inrush currents is less than or equal to the simultaneously applicable current, sets a power-on delay time for each of the groups, and determines power-on delay times for the image display apparatuses 10-1 to 10-6. In this example, a power-on delay time for the image display apparatuses 10-1 to 10-5 belonging to the group #1 is finally determined as “zero seconds” and a power-on delay time for the image display apparatus 10-6 belonging to the group #2 is finally determined as “one second”.

### (Steps S118a to 118e)

The master-side image display apparatus 10-1 transmits the power-on delay times to the slave-side image display apparatuses 10-2 to 10-6.

### (Step S119)

When the power-on delay function is used, the user performs a setting to enable the power-on delay function.

### (Step S120)

As a result of a power-off operation by the user, the power sources of the image display apparatuses 10-1 to 10-6 are turned off.

With the above processing, the power-on delay times are set in the image display apparatuses 10-1 to 10-6 and the power-on delay function is enabled. When operations of turning on the power sources are performed again, the image display apparatuses 10-1 to 10-6 set timings when the power sources are to be turned on in accordance with the set power-on delay times.

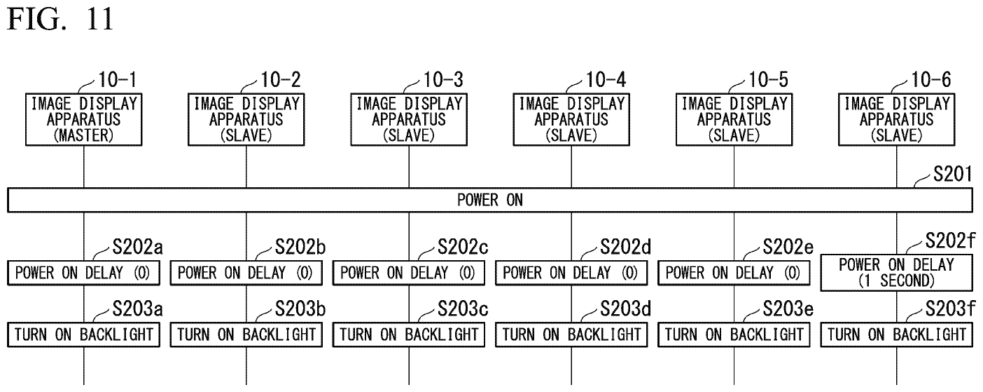

FIG. 11 is a sequence diagram showing a power source management process using a power-on delay function in the multi-display system 1 in accordance with the first example embodiment of the present invention.

### (Step S201)

A user performs operations of turning on the power sources to give power-on instructions to the image display apparatuses 10-1 to 10-6.

### (Steps S202a to 202f)

The power sources of the image display apparatuses 10-1 to 10-6 are turned on after the delay times in accordance with the set power-on delay times have passed. In this example, the power sources of the image display apparatuses 10-1 to 10-5 belonging to the group #1 are immediately turned on, and the power source of the image display apparatus 10-6 belonging to the group #2 is turned on after a power-on delay time of one second has passed.

### (Steps S203a to 203f)

When the power sources are turned on, each of the image display apparatuses 10-1 to 10-6 turns on the backlight 14. That is, the power sources of the image display apparatuses 10-1 to 10-5 are immediately turned on after the user performs operations of turning on the power sources, and each of the image display apparatuses 10-1 to 10-5 turns on the backlight 14. The power source of the image display apparatus 10-6 is turned on after one second has passed after the user performs the operations of turning on the power sources, and the image display apparatus 10-6 turns on the backlight 14.

It is to be noted that the grouping is performed in accordance with the ID numbers in the above-described example, but the grouping may be performed in accordance position numbers. ID numbers and position numbers vary depending on a connection configuration of the multi-display and/or a user's setting. For this reason, it is effective to divide the power-on delays into groups in accordance with position numbers in order to change the appearance at the time of a start-up. For example, when position numbers are sequentially allocated from top to bottom as shown in FIG. 3, an appearance in which backlights are sequentially turned on from top is obtained, and when position numbers are sequentially allocated from bottom to top as shown in FIG. 4, an appearance in which backlights are sequentially turned on from bottom is obtained.

As described above, in the present example embodiment, the image display apparatuses 10-1 to 10-6 are divided into groups on the basis of the total value of the inrush currents of the image display apparatuses 10-1 to 10-6 and the simultaneously applicable current so that the total of the inrush currents is less than or equal to the simultaneously applicable current, and the power-on delay time is set for each of the groups. In this case, the six image display apparatuses 10-1 to 20-6 are divided into the two groups, the power-on delay times are set for the image display apparatuses 10-1 to 20-6, and the maximum delay time becomes (a unit delay time×1) seconds. In contrast, with a normal power-on delay function, the delay time as a whole when the power sources are turned on becomes (a unit delay time×5) seconds. In this manner, when the multi-display system is constructed with the plurality of image display apparatuses, the present example embodiment can shorten the time from when operations of turning of the power sources are performed until when the screen displays of all the image display apparatuses can be confirmed.

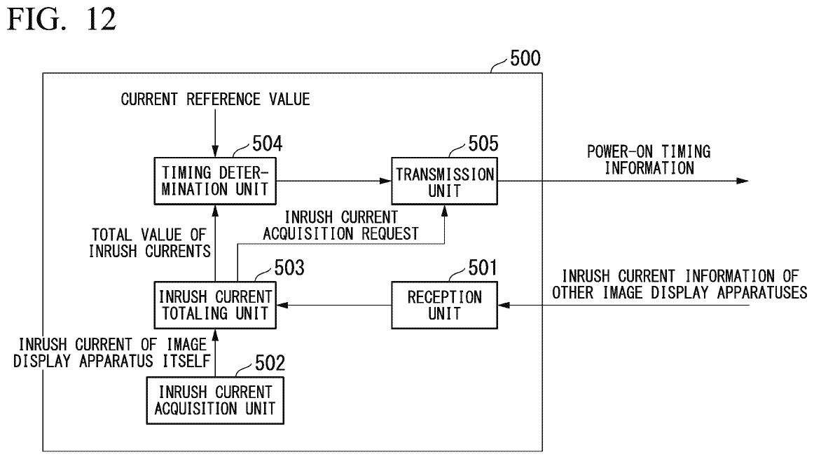

FIG. 12 is a schematic block diagram showing a basic structure of an image display apparatus in accordance with the present invention. That is, an image display apparatus 500 in accordance with the present invention includes a reception unit 501, an inrush current acquisition unit 502, an inrush current totaling unit 503, a timing determination unit 504, and a transmission unit 505.

The reception unit 501 receives inrush current information transmitted from the other image display apparatuses other than the image display apparatus itself among the image display apparatuses that configure a multi-display, wherein the inrush current information represents inrush currents when the other image display apparatuses are started up. The inrush current acquisition unit 502 acquires an inrush current when the image display apparatus itself is started up. The inrush current totaling unit 503 totals the inrush currents when the other image display apparatuses are started up and the inrush current when the image display apparatus itself is started up. The timing determination unit 504 determines timings when the other image display apparatuses, which are the transmission sources of the inrush current information, are started up on the basis of the total value of the inrush currents and a current reference value representing the value of a simultaneously applicable current. The transmission unit 505 transmits power-on timing information representing the determined timings to the other image display apparatuses.

Although the above-described example embodiments describe examples when the electronic devices are liquid crystal displays, electronic devices other than the liquid crystal displays can be applied if the plurality of electronic devices can cooperate with one another to construct a system. For example, projectors can be used as the electronic devices. In this case, one video can be formed by projecting, from a plurality of projectors, images in accordance with video signals. Moreover, lighting equipment can be used as an electronic device. In this case, an area to be illuminated can be illuminated by turning on a plurality of pieces of lighting equipment. Furthermore, a measuring instrument can be used as an electronic device. In this case, a plurality of measuring instruments are started up and an area to be measured can be measured using the plurality of measuring instruments.

Moreover, the construction management may be performed by recording a program that implements the functions of the multi-display system 1 on a computer-readable recording medium and causing a computer system to read the program recorded on the recording medium and execute the program. It is to be noted that it is assumed that the “computer system” mentioned here includes an OS and hardware such as peripheral devices.

Moreover, when a WWW system is used, it is assumed that the “computer system” also includes a web-page providing environment (or a display environment).

Moreover, “computer-readable recording medium” refers to a portable medium, such as a flexible disk, a magneto-optical disc, ROM, or CD-ROM, or a storage apparatus such as a hard disk built in a computer system. Furthermore, it is assumed that “computer-readable recording medium” includes a medium that holds a program for a given period of time, like a volatile memory inside a computer system that functions as a server or a client. Moreover, the above program may achieve some of the above-described functions and may achieve the above-described functions in combination with a program already recorded in a computer system. Moreover, the above program may be stored in a predetermined server and the program may be distributed (e.g., downloaded) via communication lines in response to a request from another apparatus.

Although example embodiments of the present invention have been described in detail with reference to the drawings, the specific structure thereof is not limited to the structures in the example embodiments, and designs and so forth that do not depart from the gist of the present invention are also included.

### DESCRIPTION OF REFERENCE SIGNS

500 image display apparatus
501 reception unit
502 inrush current acquisition unit
503 inrush current totaling unit
504 timing determination unit
505 transmission unit

1. An electronic device comprising:
a receiver that receives inrush current information that represents an inrush current when another electronic device is started up and that is transmitted from the other electronic device;
an inrush current acquirer that acquires an inrush current when the electronic device itself is started up;
an inrush current totalizer that totals the inrush current when the other electronic device is started up and the inrush current when the electronic device itself is started up;
a timing determiner that determines timings when the electronic device itself and the other electronic device are respectively started up on the basis of a total value of the inrush current of the electronic device itself and the inrush current of the other electronic device and a current reference value representing a simultaneously applicable current value; and
a transmitter that transmits power-on timing information representing the determined timings to the other electronic device.

2. The electronic device according to claim 1, wherein a plurality of other electronic devices are provided, and
the timing determiner combines and groups the electronic device itself and the plurality of other electronic devices on the basis of the inrush current information so that the total value is less than or equal to the current reference value and determines the timings for groups.

3. The electronic device according to claim 2, wherein the electronic device itself and the other electronic devices comprise image display apparatuses that configure a multi-display,
numbers are allocated to the electronic device itself and the other electronic devices, and
the timing determiner divides the electronic device itself and the plurality of other electronic devices into groups on the basis of the numbers.

4. The electronic device according to claim 3, wherein the numbers are allocated in accordance with an order in a daisy-chain connection of the electronic device itself and the plurality of other electronic devices.

5. The electronic device according to claim 3, wherein the numbers are allocated in accordance with an arrangement of the electronic device itself and the other electronic devices in the multi-display.

6. The electronic device according to claim 1, further comprising:
a backlight; and
a panel that is radiated by light from the backlight,
wherein the inrush current acquirer refers to an inrush current table showing a relationship between the backlight and the inrush current and acquires the inrush current when the apparatus device itself is started up.

7. A method for managing a power source of an electronic device, the method comprising:
receiving inrush current information that represents an inrush current when another electronic device is started up and that is transmitted from the other electronic device;
acquiring an inrush current when the electronic device itself is started up;
totaling the inrush current when the other electronic device is started up and the inrush current when the electronic device itself is started up;
determining timings when the electronic device itself and the other electronic device are respectively started up on the basis of a total value of the inrush current of the electronic device itself and the inrush current of the other electronic device and a current reference value representing a simultaneously applicable current value; and
transmitting power-on timing information representing the determined timings to the other electronic device.
